(19) United States
(12) Patent Application Publication
(10) Pub. No.: US 2013/0011316 A1
(43) Pub. Date: Jan. 10, 2013

(54) STRONTIUM CHLORIDE EXPANSIVE DISKS AND COMPRESSION WELDED CARTRIDGE AND METHOD

(76) Inventors: Ramon A. Mella, Greenfield, IN (US); George D. Boyd, New Palestine, IN (US)

(21) Appl. No.: 13/636,679

(22) PCT Filed: Mar. 23, 2011
(86) PCT No.: PCT/US11/29631

§ 371 Date: Sep. 22, 2012

(30) Foreign Application Priority Data
Mar. 24, 2010 (US) 61317142

(51) Int. Cl. C01C 1/02; B65B 61/20; B01J 8/00; F01N 3/08; B01D 53/56

(52) U.S. Cl. 423/235; 422/173; 422/311; 423/352; 53/474

(57) ABSTRACT

A device and method relating to storage of ammonia in a solid form and the subsequent release of gaseous ammonia for use in the selective catalytic reduction of NOₓ, is disclosed.

### TECHNICAL FIELD OF THE INVENTION

The present device and method relate to the storage and delivery of ammonia. Particularly, the device and method relate to storage of ammonia in a solid form and, through the application of heat, the subsequent release of gaseous ammonia for use in the selective catalytic reduction of NOₓ.

### BACKGROUND OF THE INVENTION

Compression ignition engines provide advantages in fuel economy, but produce both NOₓ and particulates during normal operation. New and existing regulations continually challenge manufacturers to achieve good fuel economy and reduce the particulates and NOₓ emissions. Lean-burn engines achieve the fuel economy objective, but the high concentrations of oxygen in the exhaust of these engines yields significantly high concentrations of NOₓ as well. Accordingly, the use of NOₓ reducing exhaust treatment schemes are being employed in a growing number of systems.

One such system is the direct addition of ammonia gas to the exhaust stream. It is an advantage to deliver ammonia directly in the form of a gas, both for simplicity of the flow control system and for efficient mixing of reducing agent, ammonia, with the exhaust gas. The direct use of ammonia also eliminates potential difficulties related to blocking of the dosing system, which are cause by precipitation or impurities, e.g., in a liquid-based urea solution. In addition, an aqueous urea solution cannot be dosed at a low engine load since the temperature of the exhaust line would be too low for complete conversion of urea to ammonia (an CO₂).

Transporting ammonia as a pressurized liquid, however, can be hazardous if the container bursts caused by an accident or if a valve or tube breaks. In the case of using a solid storage medium, the safety issues are much less critical since a small amount of heat is required to release the ammonia and the equilibrium pressure at room temperature can be—if a proper solid material is chosen—well below 1 bar. Previous designs for delivery of solid ammonia, such as ammonia saturated strontium chloride, included wrapping the material into aluminum foil balls. The balls are then placed in a canister where they are pressed under a load of up to 300 tons to reach a density of approximately 1.2 g/cc. However, the machines typically required to fill and wrap the foil balls needs to be at very high speed (6 parts per second) in order to achieve the necessary rate for high volume. In addition, such machines tend to be expensive and difficult to maintain. Finally, it can be difficult to load the balls into the machine without damaging them, in that the wrapping can become unsealed, loose and subject to leakage. Therefore, conveying the foil balls at the speed required to meet the desired volume would likely be difficult to do without damaging them.

In order to release the ammonia gas from its adsorptive or absorptive solid storage material, sufficient heat needs to be applied. In addition, the heat transfer needs to be efficient enough to reach the solid storage material through the containers or cartridge holding the material. Therefore, the present device and method relate to providing ammonia in solids for the purpose of ammonia storage and transport, and the effective delivery of heat to release the ammonia gas through thermal desorption for use in stationary and mobile applications, such as catalytic removal of NOₓ through selective catalytic reduction using ammonia.

### SUMMARY OF THE INVENTION

There is disclosed herein a device and method, each of which avoids the disadvantages of prior devices and methods while affording additional structural and operating advantages.

Generally speaking, an ammonia storage material assembly comprises a cartridge and a plurality of nestable disks comprised of a heat conductive layer and an ammonia-containing material layer.

In an embodiment there is an assembly for storing solid ammonia, the assembly comprising a cartridge having sidewalls, a plurality of nestable disks comprised of a heat conductive layer and a compacted ammonia-containing material layer, wherein the plurality of nestable disks are inserted into the cartridge such that the heat conductive layer of each disk contacts the sidewalls.

In another embodiment, a solid material disk for storing solid ammonia and releasing it as a gas in an exhaust treatment system, is set forth. The disk comprises a solid ammonia-containing material layer having an upper section formed from a substantially parallel outer wall and a top surface with a recess, and a lower section formed from a substantially angular wall and a bottom surface, and a heat conductive layer.

In yet another embodiment, the lower section of a first disk is adapted for engaging the recess of a second disk forming a stacked plurality of nested disks having a heat conductive layer alternating between each disk.

In the disclosed method for storage and delivery of ammonia, the method comprises the steps of providing a cartridge having sidewalls, providing at least a first disk and a second disk comprised of a compacted ammonia-containing material, each disk having an upper section formed from a substantially parallel outer opposing wall and a top surface having a recess, and a lower section formed from substantially angular wall and a bottom surface, providing a heat conductive layer between each disk, engaging the lower section of the first disk with the recess of the second disk, creating a stack of nested disks and heat conductive layers, and inserting the stack into the cartridge.

In another embodiment, the method further comprises the step of applying a compression force to the stack after insertion into the cartridge, and contacting the heat conductive layer to the sidewall of the cartridge. Heat is provided from a heat source to the cartridge and heat conductive layer, which affects the release of ammonia gas from the ammonia-containing material.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of the assembly for storing solid ammonia of the present invention.

FIG. 2 is a perspective view of the uncompressed plurality of nested disks and heat conductive layers of the present invention.

FIG. 3 is a perspective view of the compressed plurality of nested disks and heat conductive layers of the present invention within a cartridge.

### DETAILED DESCRIPTION OF THE INVENTION

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

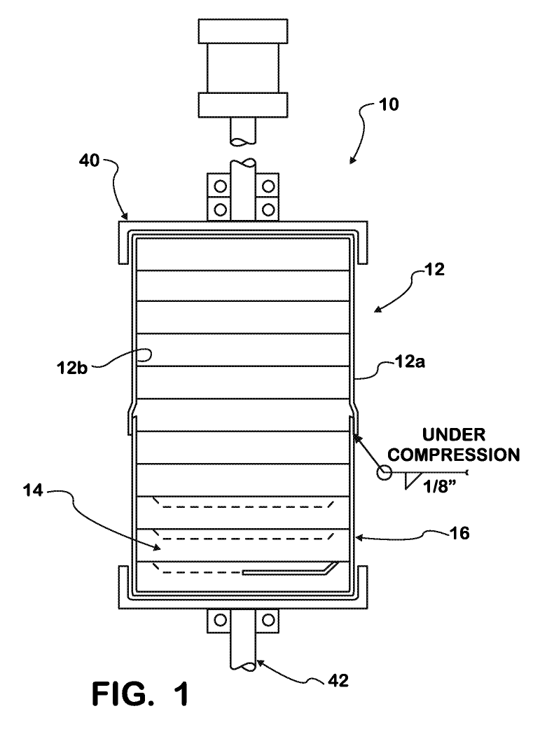

Referring to FIGS. 1-3, there is illustrated an assembly and method for storage and delivery of ammonia, specifically in a solid form, for use on a vehicle (not shown). The assembly of the present invention, generally designated by the numeral 10, is discussed with respect to ammonia storage and delivery, and specifically to supplying ammonia gas to a combustion engine. Ammonia gas is useful in the exhaust system (not shown) of a vehicle for the reduction of NOₓ. As the exhaust system of a vehicle, including that of a diesel engine, is well known, it will not be described in detail.

As shown in FIG. 1, the assembly 10 for storing solid ammonia initially comprises a cartridge 12. The cartridge 12, typically having a cylindrical shape, with exterior 12a and interior sidewalls 12b, can be constructed from any suitable material that is sturdy for loading and transporting the ammonia-containing material, but yet compressible for creating the present assembly. In addition, the material for constructing the cartridge 12 should ideally conduct heat, because the solid ammonia-containing material used in creating the disks 14 of the present invention, require heat to sublimate the solid to form a usable ammonia gas. Aluminum sheets are a suitable material for use in constructing the cartridge 12 in a known manner. Aluminum has a low mass density and excellent thermal conductivity.

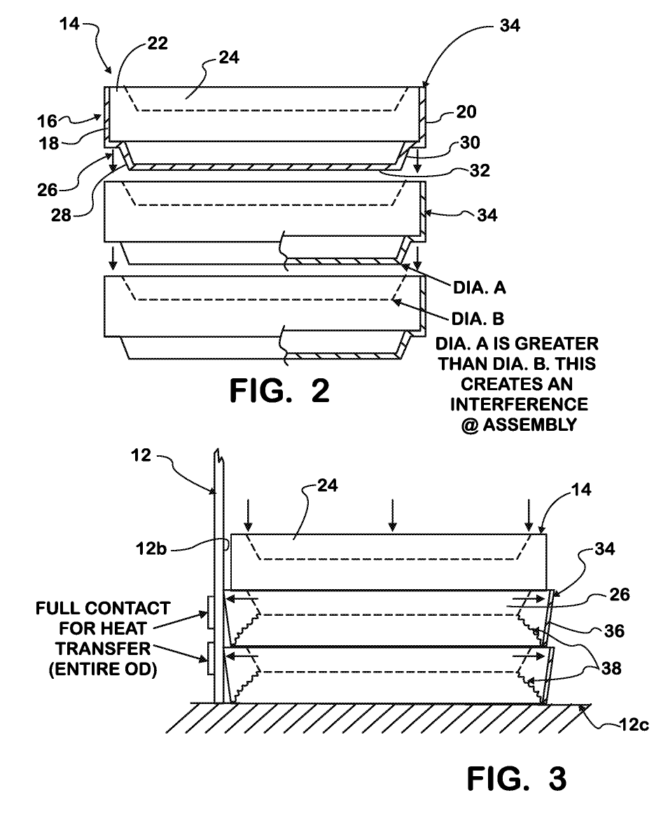

FIGS. 2 and 3 illustrate the ammonia-containing material disks 14 used in the present assembly 10. FIG. 2 specifically illustrates the disks 14 in an uncompressed form, while FIG. 3 illustrates the disks within the cartridge 12 in a compressed form. Referring initially to FIG. 2, each disk 14 includes an upper section 16 and a lower section 26. The upper section 16 is formed from substantially parallel outer walls 18, 20 and a top surface 22 having a recess 24. The lower section 26 is formed from substantially angular walls 28, 30 and a bottom surface 32. The diameter of the lower section 26 is generally greater than the diameter of the recess 24, in order to facilitate the nesting of multiple disks after loading into the cartridge 12. The significance of the differences in the diameters of the lower section 26 compared to that of the recess 24 will become apparent in the discussion below.

The disk 14 is made of an ammonia-containing material, generally in a solid form, such as a powder or granules. The disks 14 may be formed using existing powder metal press technology. Regardless of the technology used to prepare the disks, it is important to prevent the dissipation of ammonia during the formation of the disk. Suitable material for use in the disk 14 of the present assembly 10 include metal-ammine salts, which offer a solid storage medium for ammonia, and represent a safe, practical and compact option for storage and transportation of ammonia. Ammonia may be released from the metal ammine salt by heating the salt to temperatures in the range from 10° C. to the melting point to the metal ammine salt complex, for example, to a temperature from 30° to 700° C., and preferably to a temperature of from 100° to 500° C. Generally speaking, metal ammine salts useful in the present invention include the general formula M(NH₃)ₙX_{z}, where M is one or more metal ions capable of binding ammonia, such as Li, Mg, Ca, Sr, V, Cr, Mn, Fe, Co, Ni, Cu, Zn, etc., n is the coordination number usually 2-12, and X is one or more anions, depending on the valence of M, where representative examples of X are F, Cl, Br, I, SO₄, MoO₄, PO₄, etc. Preferably, ammonia saturated strontium chloride, Sr(NH₃)Cl₂, is used in creating the disk 14 of the present assembly 10.

As further shown in FIG. 2, the disk 14 includes a heat conductive layer or plate 14. The heat conductive layer 14 may be formed around the disk 14, engaging the outer opposing walls 18, 20 of the upper section 16, and the opposing walls 28, 30 and bottom surface 32 of the lower section 26. Material useful in construction of the heat conductive layer 14 includes any suitable metal material having durability and heat conductivity, including porous or dense aluminum, titanium, stainless steel or similar ammonia resistant metals or alloys. Aluminum, for its moldability and heat conductivity, is preferred.

The present assembly 10, including the combination disk 14 comprised of a compacted ammonia-containing material and heat conductive layer or plate 34, can be constructed by any suitable method. FIG. 1 provides an illustration of parts of an embodiment of the assembly process, wherein the disk 14 and heat conductive layer or plate 34, and ultimately, the entire assembly 10, may be constructed generally using the following steps: a power metal press will manufacture ammonia saturated strontium chloride disks and convey the disks to an assembly machine. The heat conductive layers or plates 34 will be loaded onto the assembly machine feeder (not shown). The assembly machine will create a stack of approximately 30 disks and heat conductive plates 34, which are nested together, and wherein the plates 34 are alternated between the disks. The assembly machine will then insert the ammonia saturated strontium chloride/heat conductive plate stack into the cartridge housing 12. The cartridge halves (if there are more than one) are assembled, and the cartridge end cap 12c is attached to the main cartridge body 12. The assembled cartridge 12 is removed from the assembly machine 40 by known automation and conveyed to a compression welding machine 40. A compression weld machine fixture 42 beings to rotate as the weld head (not shown) advances. While the cartridge 12 is under compression and rotating, the weld head applies a weld bead to fuse the two or more halves of the cartridge to the entire outer diameter of the cartridge. The compression machine unclamps, and known automation removes the device assembly 10 from the compression weld machine 40 and transfers it to the next operation (not shown). The device assembly 10 is leak tested through the use of pressure or vacuum decay equipment. An alternate leak test process may be used for ammonia detection. The device 10 may also be heated to create an internal vapor pressure.

In order to use the ammonia of the present device assembly 10 in, for example, the treatment of NOₓ in a vehicle exhaust system, it is necessary to apply a sufficient amount of heat in order to sublimate the solid ammonia into its useful gaseous form. It is contemplated that sufficient heat transfer can occur between the cartridge 12 and the ammonia-containing material disks 14, and the surrounding heat conductive layers 34 through the expansion of the disks and heat conductive layer, which when stacked together, are compressed through the application of sufficient compression pressure.

FIG. 3 provides an illustration of one embodiment of this concept. The combination disks 14 and heat conductive layers 34 are assembled together, as previously described, to form a stack. Specifically, the lower section 26 of a first disk 14 is inserted into the recess 24 of a second disk 36, nesting the disks together with the heat conductive layer 34 positioned between each disk. Compression is then applied in downward direction to the stack. Because the recess 24 of the second disk 36 has a smaller diameter than the lower section 26 of the first disk 14, the force of the downward pressure on the first disk forces an outward expansion of the second through formation of micro-fractures 38 in the second disk 36. In turn, the heat conductive layer 34 between each disk is likewise affected by the downward pressure. As shown in FIG. 3, it is contemplated that the compression of the disks and the outward expansion of the disk material, also forces the expansion outward of the heat conductive layer This expansion results in the heat conductive layer 34 contacting the interior sidewalls 12b, and thus, the entire cross section of the cartridge 12. Contacting the expanded heat conductive layer 34 to the entire interior cross section of the cartridge 12 during expansion of the disks upon compression, provides an effective means for transferring heat through the heat conductive layer to the ammonia-containing material, for the release of the gaseous ammonia for use in the exhaust system of a vehicle (not shown).

As noted, heat is required to release the ammonia gas from the solid ammonia-containing material. Heat may be applied to the cartridge 12 from a variety of sources, including but not limited to, an electrical resistive device, or hot exhaust gases from a combustion process. The heat would then transfer through the cartridge 12 to the nested disks 14 through the heat conductive layers 34 within the cartridge 12, releasing the ammonia gas within the cartridge. Although not shown, the ammonia gas may be delivered to an exhaust system through use of a controllable dosing valve to control the release of ammonia within the cartridge 12 to be used in the catalytic reduction of NOₓ in a vehicle exhaust system (not shown).

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. An assembly for storing solid ammonia, the assembly comprising:
a cartridge having sidewalls;
a plurality of nestable disks comprised of a heat conductive layer and a compacted ammonia-containing material layer;
wherein the plurality of nestable disks are inserted into the cartridge such that the heat conductive layer of each disk contacts the sidewalls.

2. The assembly of claim 1, wherein the cartridge comprises a heat conductive material.

3. The assembly of claim 1, wherein the disks have an upper section formed from a substantially parallel outer wall and a top surface having a recess, and a lower section formed from a substantially angular wall and a bottom surface.

4. The assembly of claim 3, wherein an inner diameter of the recess is less than a diameter of the lower section.

5. The assembly of claim 4, wherein the lower section of a first disk is adapted for engaging the recess of a second disk forming the plurality of nestable disks.

6. The assembly of claim 5, wherein the plurality of nestable disks further comprise alternating layers of the heat conductive layer and the compacted ammonia-containing material.

7. The assembly of claim 1, wherein the ammonia-containing material comprises a metal-ammine salt.

8. The assembly of claim 7, wherein the metal-ammine salt comprises strontium chloride.

9. The assembly of claim 1, wherein the heat conductive layer comprises a heat conductive metal.

10. The assembly of claim 9, wherein the heat conductive layer comprises aluminum.

11. A solid material disk for storing solid ammonia and releasing it as a gas in an exhaust treatment system, the disk comprising:
a solid ammonia-containing material layer having an upper section formed from a substantially parallel outer wall and a top surface with a recess, and a lower section formed from a substantially angular wall and a bottom surface; and,
a heat conductive layer.

12. The disk of claim 11, wherein a diameter of the recess is less than a diameter of the lower section.

13. The disk of claim 12, wherein the lower section is adapted for engaging the recess forming a plurality of nested disks, wherein the heat conductive layer is positioned between each disk.

14. The disk of claim 11, wherein the ammonia-containing material comprises a metal-ammine salt.

15. The disk of claim 14, wherein the metal-ammine salt comprises strontium chloride.

16. The disk of claim 11, wherein heat conductive layer comprises aluminum.

17. An ammonia storage device for use in the reduction of NOₓ in an exhaust stream, the device comprising:
a cartridge having sidewalls;
at least a first disk and a second disk, each disk comprised of a heat conductive layer and an ammonia-containing material having an upper section formed from a substantially parallel outer wall and a top surface with a recess, and a lower section formed from a substantially angular wall and a bottom surface;
wherein the first disk is adapted for engaging the second disk forming a plurality of nestable disks and the heat conductive layer contacts the sidewalls when inserted into the cartridge.

18. The device of claim 17, wherein an inner diameter of the recess is less than an outer diameter of the lower section.

19. A method for storage and delivery of ammonia, the method comprising the steps of:
providing a cartridge having sidewalls;
providing at least a first disk and a second disk, each disk comprised of a compacted ammonia-containing material and having an upper section formed from a substantially parallel outer opposing wall and a top surface having a recess, and a lower section formed from substantially angular wall and a bottom surface;
providing a heat conductive layer;
engaging the lower section of the first disk with the recess of the second disk;
creating a stack of alternating disks and the heat conductive layers; and, inserting the stack into the cartridge.

21. The method of claim 20, wherein the step of creating the stack includes nesting the disks and heat conductive layers together.

22. The method of claim 20, wherein the method further comprises the step of applying a downward compression force to the stack.

23. The method of claim 22, wherein the step of applying the compression force includes expanding the disks and heat conductive layer and contacting the sidewalls.

24. The method of claim 20, wherein the method further comprises the step of applying heat from a heat source to the cartridge and heat conductive layer and releasing ammonia gas from the ammonia-containing material.

25. The method of claim 24, wherein the method further includes releasing the ammonia gas into an exhaust system for use in the reduction of NOₓ.
